(19) United States
(12) Patent Application Publication
(10) Pub. No.: US 2011/0047840 A1
(43) Pub. Date: Mar. 3, 2011

(54) LED DISPLAY APPARATUS

(76) Inventor: SEOK S. OU, Cerritos, CA (US)

(21) Appl. No.: 12/552,098

(22) Filed: Sep. 1, 2009

(51) Int. Cl. G09F 13/18; F21V 21/00; F21V 9/00

(52) U.S. Cl. 40/546; 362/249.02; 362/231

(57) ABSTRACT

An LED display apparatus comprises two or more LED arrays for performing as a light source, a housing to house the LED arrays, transparent panels attached to the housing so that the LEDs can shed light through the side of the transparent panels, and dispersion scratches on the transparent panels for refracting, reflecting and diffusing LED light wherein the dispersion scratch is configured to form a sign, and a plurality of panels treated with fluorescent paint attached to each transparent panel for enhancing the intensity of LED light refracted or reflected. The dispersion scratch is configured to be a letter, sign, symbol or design component for being bright as against the rest of dark plain background of the transparent panel. Therefore, the part of the transparent panels having dispersion scratches becomes brighter as against the rest of dark plain background of the transparent panels.

### BACKGROUND OF THE INVENTION

The present invention relates to an LED display apparatus. More particularly, this invention relates to an LED display apparatus comprising two or more LED arrays for performing as a light source, a housing to house the LED arrays, transparent panels attached to the housing so that the LEDs can shed light through the side of the transparent panels, and dispersion scratches on the transparent panels for refracting, reflecting and diffusing LED light wherein the dispersion scratch is configured to form a sign, and a plurality of panels treated with fluorescent paint attached to each transparent panel for enhancing the intensity of LED light refracted or reflected. The dispersion scratch is configured to be a letter, sign, symbol or design component for being bright as against the rest of dark plain background of the transparent panel.

Light signs have become widespread from “OPEN” sign for businesses to destination sign for buses to warning or informational signs on the streets. Neon signs have gained popularity for such light signs because neon light is bright enough and luminous tube can be manufactured to represent letters or images. However, due to recent advancement of LED technology, LED light can also produce light bright enough to be used as light signs. Furthermore, LEDs have advantages over neon light in their extremely long life and energy saving.

Ordinary LED signs are being made by arraying or clustering a number of LEDs to function as a light source. But, this method also requires a lot of LEDs and thus consumes a lot of energy. In addition, design alternatives for signs in this method are limited because each LED has to be a design component.

Accordingly, a need for an LED display apparatus using an array of LEDs as light source and a dispersion scratch on the transparent panel as lighting sign has been present for a long time considering the expansive demands for light signs in the everyday life. This invention is directed to solve these problems and satisfy the long-felt need.

### SUMMARY OF THE INVENTION

The present invention contrives to solve the disadvantages of the prior art.

An object of the invention is to provide an LED display apparatus for lighting signs.

Another object of the invention is to provide an LED display apparatus for lighting signs, which enables a variety of design alternatives and lighting effects by using dispersion scratch on a transparent panel and fluorescent paint.

Still another object of the invention is to provide an LED display apparatus for lighting signs, which comprises several different colors.

An aspect of the invention provides an LED display apparatus comprising two or more LED arrays for performing as a light source, a housing to house the LED arrays, transparent panels attached to the housing so that the LEDs can shed light through the side of the transparent panels, and dispersion scratches on the transparent panels for refracting, reflecting and diffusing LED light wherein the dispersion scratch is configured to form a sign, and a plurality of panels treated with fluorescent paint attached to each transparent panel for enhancing the intensity of LED light refracted or reflected.

The advantages of the present invention are: (1) the LED display apparatus can provide bright light signs; (2) the LED display apparatus can provide a lot more flexibility for sign design compared to conventional neon signs or LED signs; (4) the LED display apparatus can enable a variety of design alternatives and lighting effects; and (4) the LED display apparatus can enable signs to have several different colors.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing an LED display apparatus according to an embodiment of the present invention;

FIG. 2 is a sectional view taken along 2-2 in FIG. 1 showing how an LED display apparatus can work as a sign;

FIG. 3 is a sample LED circuit diagram showing one embodiment of the present invention; and

FIG. 4 is a sectional view taken along 2-2 in FIG. 1 showing an alternative embodiment of the present invention.

### DETAILED DESCRIPTION EMBODIMENTS OF THE INVENTION

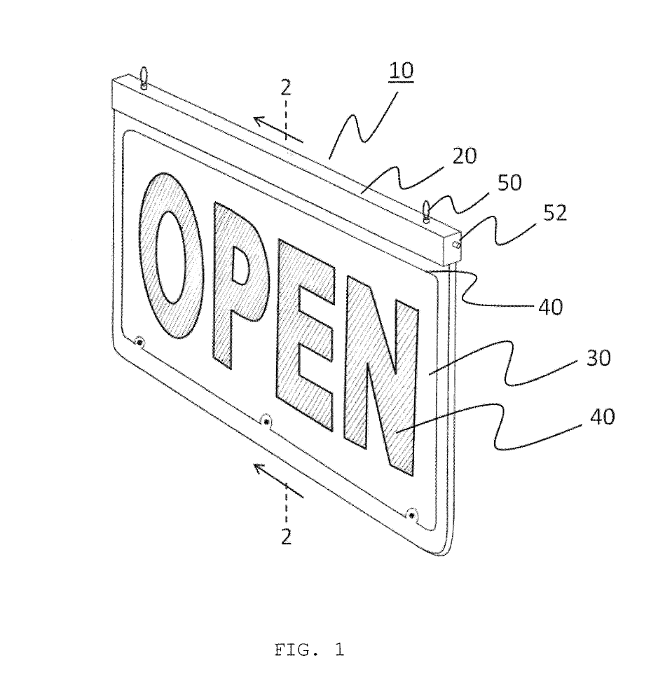

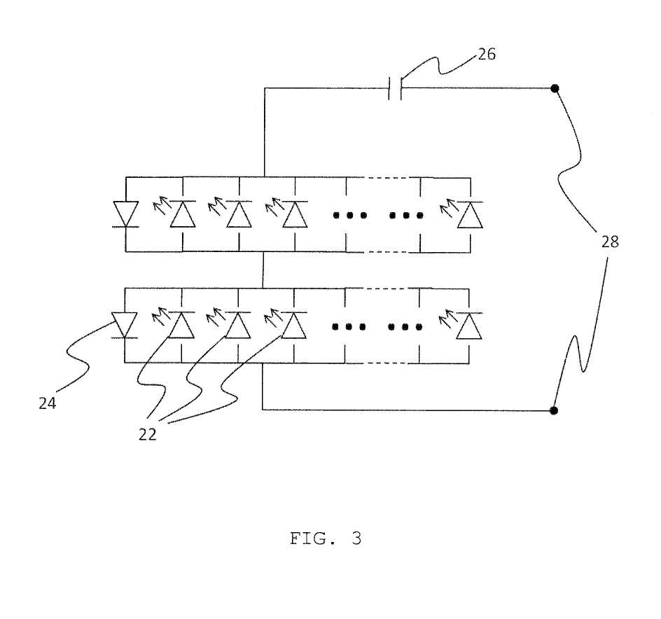

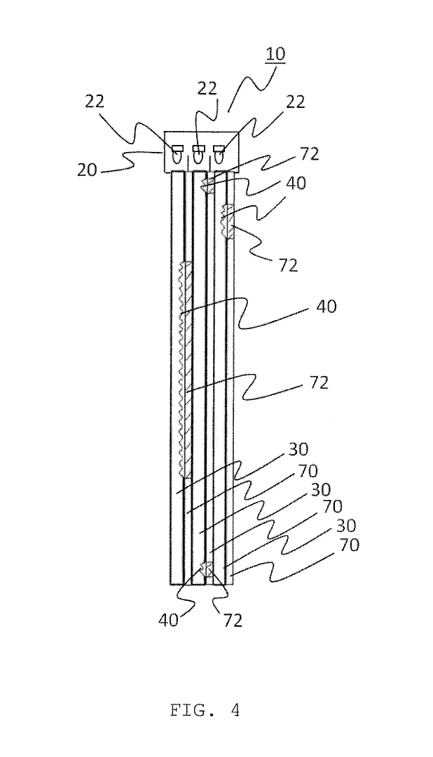

FIGS. 1-3 show an LED display apparatus 10 according to an embodiment of the present invention. FIG. 3 shows a sample LED circuit for an LED display apparatus 10. FIG. 4 shows an LED display apparatus 10 according to another embodiment of the invention.

FIG. 1 shows a perspective view showing an LED display apparatus 10 comprising two LED arrays 22 for performing as a light source wherein a plurality of LEDs 22 are arrayed in two rows; a housing 20 to house the two LED arrays 22; two transparent panels 30 of which one side is attached to the housing 20 so that the LEDs 22 can shed light through the side of the transparent panels; dispersion scratches 40 on the transparent panels 30 for refracting, reflecting and diffusing LED light wherein the dispersion scratches 40 are configured to form a sign; and two additional panels 70 treated with fluorescent paint 72 for enhancing the intensity of LED light refracted or reflected wherein each additional panel 70 treated with fluorescent paint 72 is attached to each transparent panel 30 on the side having the dispersion scratch 40 and the fluorescent paint 72 glows by reflecting the LED light; wherein the dispersion scratches 40 are configured to be a letter, sign, symbol or design component for being bright as against the rest of dark plain background of the transparent panels 30.

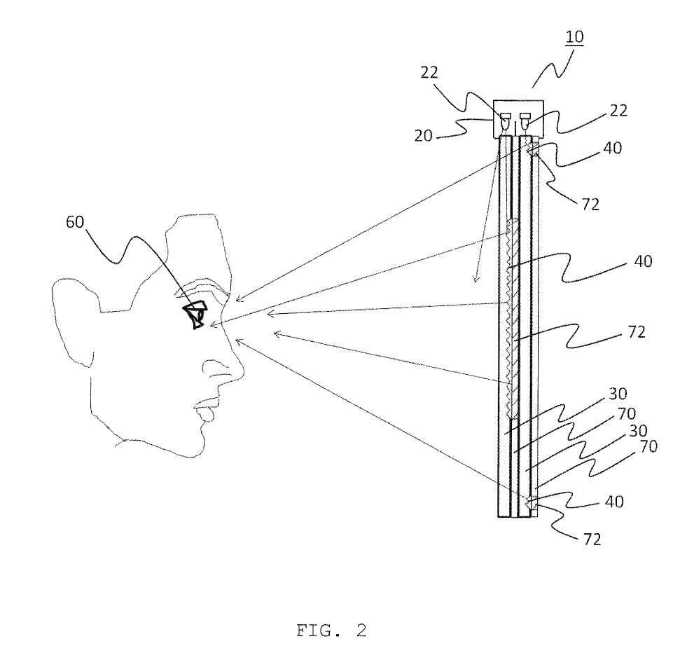

FIG. 2 shows a sectional view of the LED display apparatus 10 showing how a LED display apparatus 10 can work as a sign. The dispersion scratches 40 refract, disperse, scatter, or reflect LED lights from the LEDs 22 in the housing 20 whereas LED lights go down on the plain surface without scratches of the transparent panel 30. Mostly refracted light, in addition to reflected or scattered light, concentrates and becomes visible to viewers. Fluorescent paint 72 located right behind the scratch enhances the intensity of LED lights refracted or reflected by the scratches. Therefore, the part of the transparent panel 30 having dispersion scratches 40 becomes brighter as against the rest of dark plain background of the transparent panel 30. The dispersion scratches 40 may be configured or designed to form letters, sign, symbol or design. In FIG. 1, dispersion scratches 40 for “OPEN” were made on the front transparent panel 30 whereas dispersion scratches 40 for the surrounding line were made on the rear transparent panel 30.

Two LED arrays 22 may have different colors, for example; one array of LEDs has 50 red LEDs and the other 48 blue LEDs so that “OPEN” and surrounding line look red and blue, respectively. Fluorescent paints 72 may also have different color to enhance the color effect of the LED sign. In addition, for better sign effect, the LED light may comprise the function of flashing, blinking, dimming, etc. If this light effect is combined with sign design by scratches on the transparent panels, simple moving animation effect is possible as well.

In the preferred embodiment of the present invention, the transparent panels 30 are plastic acrylic and each LED array 22 has about 30 LEDs at intervals of about 0.25 inch. The features of the transparent panels 30 may include being transparent, ultraviolet and impact resistant, cool to the touch, excellent light transmission, high temperature resistance, recyclable, light guide, edge lighting, color effect, and/or switch in combination with light. High bright LEDs may be used, having 455-470 wavelength and 300-700 luminous intensity with the power of 22 watts. The type of dispersion scratches 40 is vertical depth drill scratch.

The two LED arrays 22 may have different light colors and the two transparent panels 30 may comprise acrylic. In addition, the acrylic may have the function of edge lighting by the LED light. The dispersion scratches 40 may be made vertically by means of drill.

The two additional panels 70 treated with fluorescent paint 72 may comprise fluorescent paint which is treated on the panels at the substantially same places as the dispersion scratches 40 are made so that the sign by the dispersion scratches 40 lights more intensely by the fluorescent paint 72. Additionally, the two additional panels 70 treated with fluorescent paint 72 may comprise fluorescent paint of more than one color for various sign design effects.

FIG. 3 is a sample LED circuit diagram for the present invention. The circuit for the plurality of LEDs may comprise a capacitor 26 and rectifying diode 24 for stable current. The power source 28 may be alternating current (AC) with or without an adaptor or direct current (DC).

The LED circuit may comprise additional component for special light effects such as dimming or flashing. The circuit for the plurality of LEDs 22 may have an IC control chip for a special effect. For example, the IC control chip may have an integrated multivibrator circuit for making the plurality of LEDs 22 flash. Alternatively, the circuit for the plurality of LEDs 22 may have a photoresistor. The plurality of LEDs may be bi-color LEDs. The plurality of LEDs 22 may have the function of dimming either by pulse-width modulation or lowering the forward current. The inside of housing 20 may comprise mirror for maximizing the downward light. Light scattering panel may be attached to the upper side of the transparent panels 30 for evenly scattering the light from LEDs.

FIG. 4 shows a sectional view showing an alternative embodiment of the present invention with one or more additional transparent panel(s) 30 and panel(s) 70 treated with fluorescent paint 72. The alternative embodiment of the LED display apparatus comprises a plurality of LED arrays 22 for performing as a light source; a housing 20 to house the plurality of LED arrays 22; a plurality of transparent panels 30 of which one side is attached to the housing so that the LED light can shed light through the side of the transparent panels 30 and the number of transparent panels 30 is the same as the number of LED arrays 22; dispersion scratches 40 on the transparent panels 30 for refracting, reflecting and diffusing LED light wherein the dispersion scratches are configured to form a sign; and a plurality of panels 70 treated with fluorescent paint 72 for enhancing the intensity of LED light refracted or reflected wherein each panel 70 treated with fluorescent paint 72 is attached to each transparent panel 30 on the side having the dispersion scratch 40 and the fluorescent paint 72 glows by reflecting the LED light; wherein the dispersion scratches 40 are configured to be a letter, sign, symbol or design component for being bright as against the rest of dark plain background of the transparent panels 30. This alternative embodiment of the present invention may have the same additional features as the first embodiment of the present invention. For example, the LED arrays 22 may have different light colors and the transparent panels 30 may comprise acrylic. The dispersion scratches 40 may be made vertically by means of drill. In addition, the plurality of panels 70 treated with fluorescent paint 72 may comprise fluorescent paint 72 which is treated on the panels at the substantially same places as the dispersion scratches 40 are made so that the sign by the dispersion scratch lights more intensely by the fluorescent paint.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An LED display apparatus comprising:
two LED arrays for performing as a light source wherein a plurality of LEDs are arrayed in two rows;
a housing to house the two LED arrays;
two transparent panels of which one side is attached to the housing so that the LEDs can shed light through the side of the transparent panels;
dispersion scratches on the transparent panels for refracting, reflecting and diffusing LED light wherein the dispersion scratches are configured to form a sign; and
two additional panels treated with fluorescent paint for enhancing the intensity of LED light refracted or reflected wherein each panel treated with fluorescent paint is attached to each additional transparent panel on the side having the dispersion scratch and the fluorescent paint glows by reflecting the LED light;
wherein the dispersion scratches are configured to be a letter, sign, symbol or design component for being bright as against the rest of dark plain background of the transparent panels.

2. The LED display apparatus of claim 1, wherein the two LED arrays have different light colors.

3. The LED display apparatus of claim 1, wherein the two transparent panels comprise acrylic.

4. The LED display apparatus of claim 3, wherein the acrylic has the function of edge lighting by the LED light.

5. The LED display apparatus of claim 1, wherein the dispersion scratches are made vertically by means of drill.

6. The LED display apparatus of claim 1, wherein the two additional panels treated with fluorescent paint comprise fluorescent paint which is treated on the panels at the substantially same places as the dispersion scratches are made so that the sign by the dispersion scratches lights more intensely by the fluorescent paint.

7. The LED display apparatus of claim 6, wherein the two additional panels treated with fluorescent paint comprise fluorescent paint of more than one color for various sign design effects.

8. The LED display apparatus of claim 1, wherein the circuit for the plurality of LEDs comprises a capacitor and rectifying diode for stable current.

9. The LED display apparatus of claim 1, wherein the circuit for the plurality of LEDs has an IC control chip.

10. The LED display apparatus of claim 9, wherein the IC control chip has an integrated multivibrator circuit for making the plurality of LEDs flash.

11. The LED display apparatus of claim 1, wherein the circuit for the plurality of LEDs has a photoresistor.

12. The LED display apparatus of claim 1, wherein some or all of the plurality of LEDs are bi-color LEDs.

13. The LED display apparatus of claim 1, wherein some of all of the plurality of LEDs have the function of dimming either by pulse-width modulation or lowering the forward current.

14. The LED display apparatus of claim 1, wherein the inside of housing is made of mirror for maximizing the downward light.

15. The LED display apparatus of claim 1, wherein light scattering panel is attached to the upper side of the transparent panel for evenly scattering the light from LEDs.

16. An LED display apparatus comprising:
a plurality of LED arrays for performing as a light source;
a housing to house the plurality of LED arrays;
a plurality of transparent panels of which one side is attached to the housing so that the LED light can shed light through the side of the transparent panels and the number of transparent panels is the same as the number of LED arrays;
dispersion scratches on the transparent panels for refracting, reflecting and diffusing LED light wherein the dispersion scratches are configured to form a sign; and
a plurality of panels treated with fluorescent paint for enhancing the intensity of LED light refracted or reflected wherein each panel treated with fluorescent paint is attached to each transparent panel on the side having the dispersion scratch and the fluorescent paint glows by reflecting the LED light;
wherein the dispersion scratches are configured to be a letter, sign, symbol or design component for being bright as against the rest of dark plain background of the transparent panels.

17. The LED display apparatus of claim 16, wherein the LED arrays have different light colors.

18. The LED display apparatus of claim 16, wherein the transparent panels comprise acrylic.

19. The LED display apparatus of claim 16, wherein the dispersion scratches are made vertically by means of drill.

20. The LED display apparatus of claim 16, wherein the plurality of panels treated with fluorescent paint comprise fluorescent paint which is treated on the panels at the substantially same places as the dispersion scratches are made so that the sign by the dispersion scratch lights more intensely by the fluorescent paint.
